(19) United States
(12) Patent Application Publication
(10) Pub. No.: US 2007/0192761 A1
(43) Pub. Date: Aug. 16, 2007

(54) Method for adding integrity information to portable executable (PE) object files after compile and link steps

(76) Inventors: Ravi Sahita, Beaverton, OR (US); Uday Savagaonkar, Beaverton, OR (US); Travis Schluessler, Hillsboro, OR (US); Rajan Ralanivel, West Orange, NJ (US)

Correspondence Address: Michael J. Mallie;BLAKELY, SOKOLOFF, TAYLOR & ZAFMAN LLP, Seventh Floor, 12400 Wilshire Boulevard, Los Angeles, CA, 90025, US

(21) Appl. No.: 11/355,859

(22) Filed: Feb. 15, 2006

(51) Int. Cl. G06F 9/45

(52) U.S. Cl. 717/140

(57) ABSTRACT

A method and apparatus for adding integrity information to portable executable object files after compile and link steps is described. In one embodiment, the invention is a method. The method includes compiling and linking a portable executable file with a data section for aiding in integrity measurement of a measured program when the measured program is loaded into memory. The method further includes overwriting data fields of the data section with an offset before the file is loaded into the memory.

### RELATED APPLICATIONS

This application is related to the U.S. patent application Ser. No. 11/173,851 filed Jun. 30, 2005, titled Signed Manifest for Run-Time Verification of Software Program Identity and Integrity, and U.S. patent application Ser. No. 11/173,587 filed Jun. 30, 2005, titled Generating and Communicating Information On Locations of Program Sections In Memory.

### FIELD

The present invention relates to the field of software integrity verification; more particularly, the present invention relates to a modified format for Portable Executable (PE) file formats including integrity information.

### BACKGROUND

Worms, viruses, and other forms of malware are increasingly abundant in today's digital environment. Such hardware, software, firmware, etc. when included into a computer system can bring about very harmful results. Worms and viruses are now capable of modifying critical kernel and/or user-space components of a computer system while the components are loaded into a memory. The effects can decrease the efficiency of a system, destroy information within a system, leak private information from a system, infect a system, and otherwise make a computer system unstable.

Because of the increased abundance of malware, software programs have been developed to detect and/or prevent malware from “infecting” a computer system. As used, an “infected” system is a system being influenced by any form of malware that may bring about any type of undesirable consequence to the system. When a system becomes infected by malware, the consequences can vary from reduced system efficiency, breaches in system security and privacy, spreading the infection to other systems in a networked computing environment, etc.

Programs that currently monitor a system are inherently insecure because the programs depend on the circular relationship of an operating system's infrastructure. That is, a kernel level or ring-0 program can only be monitored by another kernel level or ring-0 program. Furthermore, a user space or ring-3 program is also monitored by a kernel space or ring-0 program. In fact, a ring-3 program cannot be monitored by another ring-3 program unless it does so through a kernel space or ring-0 program. However, an operating system is not easily divisible into discrete levels of operation, and methods of monitoring program integrity of a single level are inherently insecure.

Another attempt to protect a computer system from the ill effects of malware is driver signing. However, the integrity information used to verify a driver is stored in a file separate from the driver being monitored. Thus, the integrity information of a driver signature is made unavailable to some programs, or requires the programs to read information from a separate file. Such a task becomes exceedingly difficult and/or unreliable for kernel components.

A further complication to protecting a computer system from the effects of malware exists when the integrity of a software component is not monitored as the component is loaded into memory and after it is loaded into memory. In this case, harmful software may be installed into a computer system and allowed to run before integrity information for the software is known or verified.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a system to measure integrity information from a modified PE object file.

FIG. 2 illustrates a flow diagram for an overview of creating and using modified PE files including integrity information.

FIG. 3 illustrates one embodiment of a process for preparing a modified PE object file.

FIG. 4 illustrates one embodiment of a process for integrity verification of the measured program using a modified PE object file.

FIG. 5 illustrates an exemplary computer system.

### DETAILED DESCRIPTION

A method and apparatus for adding integrity information to portable executable (PE) object files after compile and link steps is described. In one embodiment, the invention is a method. The method includes compiling and linking a portable executable file with a data section for aiding in integrity measurement of a measured program when the measured program is loaded into memory. By modifying the PE file format, no changes are needed to stock compilers and linkers of an operating system utilizing the PE file format.

The method further includes overwriting data fields of the data section with an offset before the file is loaded into the memory. Beneficially, a system may easily utilize the modified file format including integrity information with no changes to stock setup, and with very minor changes, amounting to including simple code extensions, to existing PE files. The PE file, with the data section is then loaded into memory.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

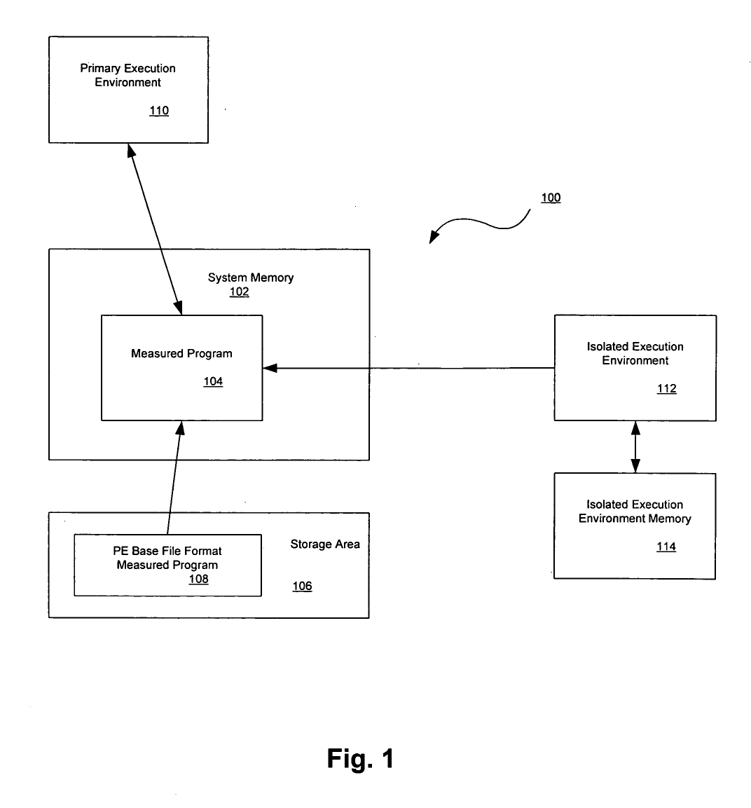

FIG. 1 is a block diagram of one embodiment of a system to measure integrity information associated with a Portable Executable (PE) object file. A PE file is a file format that includes information that an operating system needs to manage executable code as well as the code and data of the program itself. Storage area 106 of computer system 100 stores a PE file base format for a program to be measured. System 100 measures the integrity of measured program 104 when measured program is loaded into memory from storage area 106. System 100 also includes a primary execution environment 110 for the normal execution of a program, such as measured program 104.

In an embodiment of a computing system 100, the system further includes an isolated execution environment 112 that is coupled with an isolated execution environment memory 114. The isolated execution environment 112 also has access to the measured program so that isolated execution environment 112 can aid computer system 100 in verifying integrity information of a measured program, such as measured program 104, using a PE file format 108 of the measured program 108.

Isolated execution environment 112 can be viewed as a secondary processing entity where primary execution environment would be the first processing entity. In one embodiment, secondary processing entity or isolated execution environment 112, can be a virtual machine, auxiliary processor, a sequestered core, a basic input/output system (BIOS)/firmware component such as system management mode (SMM), or any other logically or physically separate processing unit. In another embodiment, isolated execution environment 112 and isolated execution environment memory 114 may be remote from the computing system 100, for a remote integrity verification system.

The secondary processing entity, according to an embodiment of computing system 100, has several properties associated with it. One property of isolated execution environment 112 is that isolated execution environment 112 has access to the memory space within system memory 102 used by the measured program 104. A second property of the isolated execution environment 112 is that isolated execution environment 112 can extract processor locality information from within system memory 102 for measured program 104. Finally, for one embodiment, isolated execution environment 112 is separated from primary execution environment 110 so that a program executed in primary execution environment 110 does not affect the isolated execution environment 112.

Thus, isolated execution environment 112 can measure integrity information of a program, such as measured program 104, using a modified PE file format according to the embodiments discussed below, without being subject to possible malware attacks. Such modification to the PE file format includes adding data sections that aid in integrity information measurement. When the file format is modified to include new data sections (discussed below), measurement results obtained from the new PE file sections can be used in diverse areas such as policy based end-point access control, remediation, etc. Furthermore, by modifying the PE file format utilized by a computer system, such as computing system 100, no changes are needed to stock compilers and linkers of the operating system. Beneficially, a system may easily utilize the modified file format including integrity information with no changes to stock setup, and with very minor changes, amounting to including simple code extensions, to existing PE files.

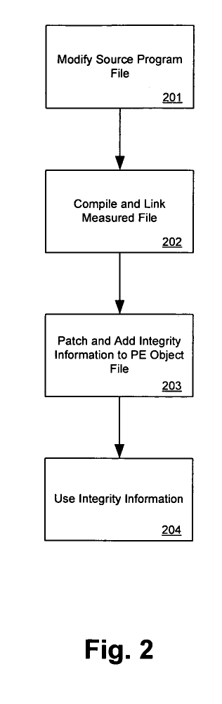

FIG. 2 is a flow diagram, according to one embodiment, of an overview of creating and using PE files including integrity information. According to an embodiment of the present invention, program source files are modified 201 to include data structures for integrity measurement using a computer system, such as computing system 100. In one embodiment, the program source file is a program file written in the American National Standards Institute (ANSI), ANSI X3.159-1989 “Programming Language C” programming language.

The modified source file is then compiled and linked 202 using the standard compiler and linker available as part of an operating system that employs PE file format in the operating system. When the source file is compiled, a PE object file is produced.

After the PE object file is produced, integrity information is added 203 to the PE object file. Because integrity information, such as an integrity manifest, is added to the standard PE object file, the PE object file is patched 203 to correct for an offset of various sections of the PE object file. In one embodiment, the integrity information added to the PE object file is used 204 to verify the processed PE object file's integrity. Each element of FIG. 2 is described in more detail below.

In one embodiment, data sections are added to a PE object file. These data sections may be added to the PE object file programmatically, manually, or through linker options. Furthermore, the changes to the PE object files may be isolated in a single source file and advertised through a header file. In one embodiment, a C source file contains the program changes and is advertised using a C source header. The header file is then included in the software to be measured, such as measured program 104. In one embodiment, a standard ‘#include’ statement is included in the software code of the program to be measured so that the C file can be linked with the measured program 104 using a standard compiler and linker. In another embodiment, the C source file may be compiled into a standard or non-standard library. In yet another embodiment, a linker with modified linker options can add the data structures discussed below to the final PE object file on its own volition. Thus, the data structures discussed below are used by an isolated execution environment of a computing system to perform integrity verification. One skilled in the art will recognize that that data types and data structures discussed below are representative of many options available to a software programmer. There are many alternative and suitable data structures capable of serving the purposes discussed below.

In one embodiment, a data type is introduced in the PE object file of the measured program. The data type holds the start and end virtual addresses for any section of interest of the measured program. The section of interest of a measured program refers to any section that will be loaded into system memory and will be integrity verified by an isolated execution environment.

TABLE 1

```
typedef struct_sec_info {
    unsigned long sec_start;
    unsigned long sec_end;
} ham_sec_info_t;
```

The data type introduced in Table 1 is used, in one embodiment, to instantiate an array of elements of the data type ham_sec_info. The array holds the start and end addresses of each section of interest of the PE object file that will be integrity checked. In one embodiment, the array holds the start and end addresses of .text and .rdata sections found in a PE file. A .text section contains program operating codes that will be executed in a primary execution environment. A .rdata section contains constant, or read-only, data elements specified by the measured program. An instantiation of an array of the type discussed above, according to one embodiment, is illustrated in Table 2.

TABLE 2

#pragma data_seg (“ham_rwdt”)
ham_sec_info_t ham_sec_info[8] = {

{(unsigned long) main, (unsigned long) main},
{(unsigned long) main, (unsigned long) main},
{(unsigned long) main, (unsigned long) main},
{(unsigned long) main, (unsigned long) main},
{(unsigned long) main, (unsigned long) main},
{(unsigned long) main, (unsigned long) main},
{(unsigned long) main, (unsigned long) main},
{(unsigned long) main, (unsigned long) main},

};
void* ham_preferred_base = (void*) 0xffff;
void* ham_actual_based = (void*) main;
#pragma data_set( )

The data structure, illustrated in Table 2, contains a size limitation of 8 for the section information to be integrity checked. However, one skilled in the art will recognize that the size limitation may be changed to support any number of sections. Furthermore, “main” is merely used as a relocatable symbol for the measured program. Any relocatable symbol may be used in the data structure. Further, the relocatable symbol will eventually be overwritten, after the modified PE object file has been compiled and linked, with an adjusted value including an offset. The adjustment is the difference between where the PE file gets loaded in memory and the preferred address specified in the PE file header “PreferredBase” attribute. Thus, in one embodiment, all fields except ham_preferred_base, as discussed in connection with Table 2, will be patched by the operating system with an adjusted address value pair.

Although the PE object file sections discussed above are inserted into a PE file programmatically, PE files may alternatively be created using linker options.

In one embodiment a second section is added to the PE Object file of the measured program. The second file is compiled and linked as a read-only data section, as illustrated in Table 3 below.

TABLE 3

#pragma section (“ham_rodt”, read)
declspec (allocate (“ham_rodt”)) unsigned int
ham_num_sections;
unsigned int ham_num_sections = 1;
declspec (allocate (“ham_rodt”)) unsigned char
ham_manifest_buf[1024*1024];
unsigned char ham_manifest_buf[1024*1024] = “This is to
initialize HAM management”;
declspec (allocate (“ham_rodt”)) unsigned int
ham_manifest_size;
unsigned int ham_manifest_size = 1;
#pragma section (“ham_rodt”)

As illustrated above, the constant variable ham_manifest_buf reserves space in a PE object file to attach an integrity manifest for the PE file. The integrity manifest is a structure that contains integrity check values (ICVs) for each section of a PE object file that is measured by a computing system. In one embodiment, the integrity manifest further describes what each section of interest of a measured programs PE file should contain.

With respect to Table 3, the variable ham_manifest_size reserves the space of the signed integrity manifest that will be inserted into the PE object file. Finally, the variable ham_num_sections variable defines the total number of section of the measured program's PE object file that will be measured. All of these values are written after the modified format PE file has been produced by compiling and linking the measured program's source files.

The data structures illustrated and discussed above, are provided by way of example. The initialization values are merely placeholders that will later be written over, as described above. Furthermore, the labels, names, and arrangements of the data structures are not essential to the embodiments of the current invention. One skilled in the art will recognize that other data types, initialization values, arrangements, etc. can be used to implement the modifications to the PE object files.

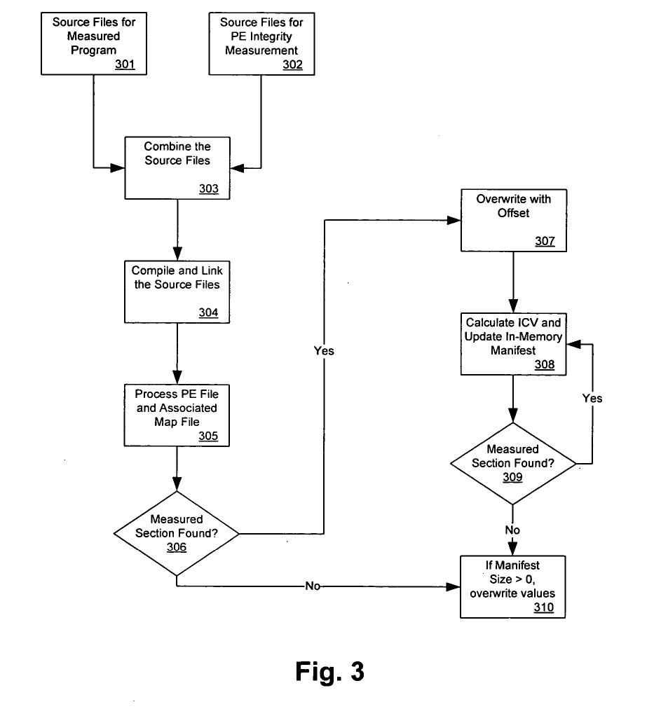

FIG. 3 illustrates a process for preparing a modified PE object file for integrity checking. The process is performed by processing logic that may comprise hardware (circuitry, dedicated logic, etc.), software (such as is run on a general purpose computer system or a dedicated machine), or a combination of both.

In one embodiment, the process begins by processing logic gathering the software code that will be compiled and linked (processing blocks 301 and 302). This includes source files for the measured program (processing block 301) and source files that provide integrity measurement features for a PE object file (processing block 302). Next, processing logic combines the source files in preparation of the source files being compiled and linked (processing block 303).

The modified source code of the measured program, including the data structures discussed above in tables 1-3, is compiled and linked to generate a PE object file and an associated map file for the linked program (processing blocks 304). The map file includes a list of the offset values for variables of the PE file. In another embodiment, the map file and associated information can be obtained directly from the linker.

The PE file and associated map file are then processed, by processing logic, to locate the integrity check variables for integrity measurement (processing block 305). Processing block 305 is described in greater detail below. Next, processing logic determines whether a measured section of the measured program is found (processing block 306). In one embodiment, the measured section is a section of interest of the measured program. If no measured section is found, then processing logic proceeds to processing block 310 (discussed below).

However, if a measured section is found, then ham_sec_info, as discussed in connection with Table 2 above, start and end array elements are overwritten with an offset (processing block 307). In one embodiment, the values used to overwrite the initialized values for ham_sec_info are the “PreferredBase” attribute value combined with a relative virtual address (RVA) value generated by the linker at processing block 304 (processing block 307). Further, the values used to overwrite the section information for sections sec_start and sec_end values is the “Preferred Base” attribute value combined with the RVA value generated by the linker and further combined with the section size (processing block 307). When the operating system loads the PE file into memory, the adjustment offset values noted above essentially patch the start and end pair values to the in-memory start and end virtual address of the section of the measured program that will be integrity checked.

Next, for the measured section found at processing block 306, processing logic calculates integrity check value(s) and saves the values to an in-memory integrity manifest (processing block 308). If measured section(s) are found again by processing logic, then processing block 308 is repeated. By repeating processing block 308 while measured sections continue to be found by processing logic, ICVs are calculated for each section of interest for the measured program. However, if no remaining measured sections are found, processing logic proceeds to processing block 310.

If the integrity manifest is not empty, i.e. manifest has a size greater than zero, processing logic locates, using the map file, ham_manifest_buf and ham_manifest_size variables in the modified PE object file and overwrites corresponding values in the integrity manifest with the variables from the modified PE object file (processing block 310). Thus, the PE object file, including integrity information, is patched to correct for the added integrity information.

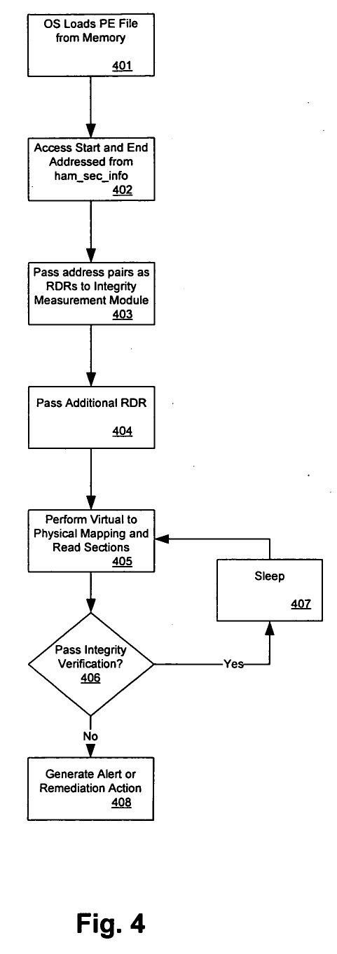

FIG. 4 illustrates a process for integrity verification of the measured program when the measured program is loaded into memory. The process is performed by processing logic that may comprise hardware (circuitry, dedicated logic, etc.), software (such as is run on a general purpose computer system or a dedicated machine), or a combination of both.

The process begins when the operating system loads a program, including the PE file discussed in FIG. 3, into memory (processing block 401). In one embodiment, the memory location where the program and PE file are loaded into memory is equal to the preferred base. In another embodiment, the location may be modified by an offset.

Next, processing logic accesses the start and end pairs of virtual addresses contained in the ham_sec_info array (processing block 402). The start and end address pairs for .text and .rdata sections indicate sections of interest to be measured.

In one embodiment, processing logic then passes start and end address pairs to the isolated execution environment as resource data records (RDRs) (processing block 403). The RDRs are abstract data structures that describe and define the sections of interest that will be integrity checked. One additional RDR is passed to the isolated execution environment that refers to the address and size of the ham_manifest_buf variable in memory (processing block 404). In one embodiment, processing logic passes the RDRs as the result of an explicit send from the primary execution environment to the isolated execution environment. In another embodiment, processing logic passes the RDR implicitly by causing isolated execution environment to read the RDRs. In yet another embodiment, RDRs may be passed by any combination of explicit and implicit passes.

After processing logic passes the RDRs to the isolated execution environment, processing logic of the isolated execution environment utilizes the RDR data to perform a virtual to physical mapping of the address of the sections of interest (processing block 405). From the mapping, the sections of the measured program and the integrity manifest located at the mapped physical address are read by integrity verification logic of the isolated execution environment, using direct memory access (DMA) (processing block 405). In an alternative embodiment, the isolated execution environment may be a remote processing environment for remotely verifying the integrity of software on a platform.

In one embodiment, the integrity verification logic of the isolated execution environment then determines whether the .text and .data sections pass integrity verification based on data from the RDRs (processing block 406). If the sections pass integrity verification, the verification logic will sleep for a predetermined time interval before attempting to verify the integrity of the sections again (processing block 407). However, in another embodiment, verification logic does not sleep at all. Instead, verification logic scans other sections of interest or other measured programs thereby causing a delay before attempting to verify the integrity of the sections again (processing block 407).

If the sections fail to pass integrity verification, processing logic may generate an alert to trigger a warning that the PE file may contain malware (processing block 408). Processing logic may also take any remediation action appropriate to the warning generated, such as notifying a user, shutting down a computer system, etc. (processing block 408). Any combination of alerts and/or remediation actions can be used if a section fails to pass integrity verification.

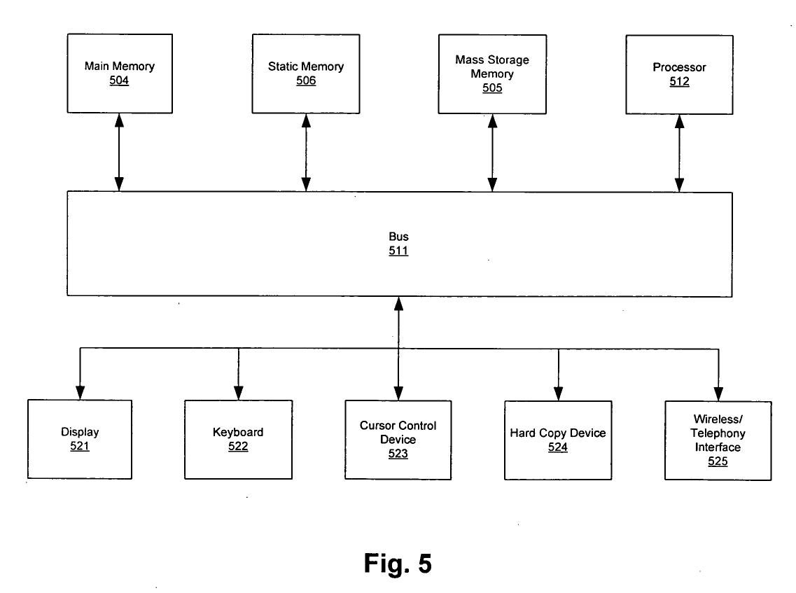

FIG. 5 is a block diagram of an exemplary computer system that may perform one or more of the operations described herein. Referring to FIG. 5, computer system 500 may comprise an exemplary client or server computer system. Computer system 500 comprises a communication mechanism or bus 511 for communicating information, and a processor 512 coupled with bus 511 for processing information. Processor 512 includes a microprocessor, but is not limited to a microprocessor, such as, for example, Pentium™, PowerPC™, Alpha™, etc.

System 500 further comprises a random access memory (RAM), or other dynamic storage device 504 (referred to as main memory) coupled to bus 511 for storing information and instructions to be executed by processor 512. Main memory 504 also may be used for storing temporary variables or other intermediate information during execution of instructions by processor 512.

Computer system 500 also comprises a read only memory (ROM) and/or other static storage device 506 coupled to bus 511 for storing static information and instructions for processor 512, and a data storage device 507, such as a magnetic disk or optical disk and its corresponding disk drive. Data storage device 507 is coupled to bus 511 for storing information and instructions.

Computer system 500 may further be coupled to a display device 521, such as a cathode ray tube (CRT) or liquid crystal display (LCD), coupled to bus 511 for displaying information to a computer user. An alphanumeric input device 522, including alphanumeric and other keys, may also be coupled to bus 511 for communicating information and command selections to processor 512. An additional user input device is cursor control 523, such as a mouse, trackball, trackpad, stylus, or cursor direction keys, coupled to bus 511 for communicating direction information and command selections to processor 512, and for controlling cursor movement on display 521.

Another device that may be coupled to bus 511 is hard copy device 524, which may be used for marking information on a medium such as paper, film, or similar types of media. Another device that may be coupled to bus 511 is a wired/wireless communication capability 525 to communication to a phone or handheld palm device.

Note that any or all of the components of system 500 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method, comprising:
compiling and linking a measured program to produce a portable executable (PE) file with a data section for aiding in integrity measurement of the measured program when the measured program is loaded into memory; and
overwriting data fields of the data section with an offset before the PE file is loaded into the memory.

2. The method of claim 1, comprising:
loading the PE file with the data section into the memory.

3. The method of claim 2, further comprising:
initializing the data section with a predetermined relocatable symbol; and
adjusting the predetermined relocatable symbol by the offset to patch the data section, the offset being the difference between where the portable executable file is to be loaded in memory and a preferred base address of the portable executable file specified in the PE file on a disk.

4. The method of claim 1, wherein the data section includes a data structure to hold start and end virtual addresses for sections of the portable executable file, a writable data structure of the portable executable file for integrity measurement, and a read only data section whose values are written after the PE file is compiled and linked for use by an integrity measurement engine.

5. The method of claim 4, wherein in memory start and end virtual addresses for the sections of the portable executable file are patched to the in-memory start and end addresses of the section of the portable executable section to be measured.

6. The method of claim 5, wherein the start and end addresses reference the start and end addresses of text and data sections of the portable executable file to be measured.

7. The method of claim 6, comprising:
passing the start and end addresses of text and data sections of the portable executable file to be measured to an integrity measurement module; and
the integrity measurement module verifying the integrity of text and data sections defined by the start and end addresses with an integrity check value generation engine.

8. An article of manufacture, comprising:
a machine readable medium including data that, when accessed by a machine, cause the machine to perform operations comprising,
compiling and linking a measured program to produce a portable executable (PE) file with a data section for aiding in integrity measurement of the measured program when the measured program is loaded into memory; and
overwriting data fields of the data section with an offset before the PE file is loaded into the memory.

9. The article of manufacture of claim 8, wherein the machine readable medium further includes data that causes the machine to perform operations comprising:
loading the PE file with the data section into the memory.

10. The article of manufacture of claim 9, wherein the machine readable medium further includes data that causes the machine to perform operations comprising:
initializing the data section with a predetermined relocatable symbol; and
adjusting the predetermined relocatable symbol by the offset to patch the data section, the offset being the difference between where the PE file is to be loaded in memory and a preferred base address of the file specified in the PE file on a disk.

11. The article of manufacture of claim 8, wherein the data section includes a data structure to hold start and end virtual addresses for sections of the portable executable file, a writable data structure of the portable executable file for integrity measurement, and a read only data section whose values are written after the PE file is compiled and linked for use by an integrity measurement engine.

12. The article of manufacture of claim 11, wherein in memory start and end virtual addresses for the sections of the portable executable file are patched to the in-memory start and end addresses of the section of the portable executable section to be measured.

13. The article of manufacture of claim 12, wherein the start and end addresses reference the start and end addresses of text and data sections of the portable executable file to be measured.

14. The article of manufacture of claim 13, wherein the machine readable medium further includes data that causes the machine to perform operations comprising:
passing the start and end addresses of text and data sections of the portable executable file to be measured to an integrity measurement module; and
the integrity measurement module verifying the integrity of text and data sections defined by the start and end addresses with an integrity check value generation engine.

15. A system comprising:
a processor;
a main memory controller coupled to the processor; and
a machine readable medium including data that, when accessed by a machine, cause the machine to perform operations comprising,
compiling and linking a measured program to produce a portable executable (PE) file with a data section for aiding in integrity measurement of the measured program when the measured program is loaded into memory; and
overwriting data fields of the data section with an offset before the PE file is loaded into the memory.

16. The system of claim 15, wherein the machine readable medium further includes data that causes the machine to perform operations comprising:
loading the PE file with the data section into the memory.

17. The system of claim 16, wherein the machine readable medium further includes data that causes the machine to perform operations comprising:
initializing the data section with a predetermined relocatable symbol; and
adjusting the predetermined relocatable symbol by the offset to patch the data section, the offset being the difference between where the PE file is to be loaded in memory and a preferred base address of the portable executable file specified in the PE file on a disk.

18. The system of claim 15, wherein the data section includes a data structure to hold start and end virtual addresses for sections of the portable executable file, a writable data structure of the portable executable file for integrity measurement, and a read only data section whose values are written after the PE file is compiled and linked for use by an integrity measurement engine.

19. The system of claim 18, wherein in memory start and end virtual addresses reference the patched start and end addresses of text and data sections of the portable executable file to be measured.

20. The system of claim 15, wherein the machine readable medium further includes data that causes the machine to perform operations comprising:
passing the start and end addresses of text and data sections of the portable executable file to be measured to an integrity measurement module; and
the integrity measurement module verifying the integrity of text and data sections defined by the start and end addresses with an integrity check value generation engine.
